(19) United States
(12) Patent Application Publication
(10) Pub. No.: US 2010/0190131 A1
(43) Pub. Date: Jul. 29, 2010

(54) REAR DELIVERY UNIT WITH INFRASTRUCTURE IN CABINET DRAWER

(76) Inventors: Tom Benfield, York, SC (US); Joe Bria, Waxhaw, NC (US); John Helgesen, Rock Hill, SC (US); Austin Unsworth, Fort Mill, SC (US)

Correspondence Address: Beusse Wolter Sanks Mora & Maire, 390 N. ORANGE AVENUE, SUITE 2500, ORLANDO, FL, 32801, US

(21) Appl. No.: 12/624,396

(22) Filed: Nov. 23, 2009

Related U.S. Application Data
(60) Provisional application No. 61/117,208, filed on Nov. 23, 2008.

(51) Int. Cl. A61G 15/16

(52) U.S. Cl. 433/79

(57) ABSTRACT

Disclosed is a dental utility system for managing dental utilities, including a dental utility housing, a dental delivery assembly base fixed to the front side of the dental utility housing, and a dental delivery assembly main arm horizontally pivotably connected to the dental delivery assembly base and which permits vertical movement of a dental delivery assembly main arm distal end. The dental delivery assembly base and a dental delivery assembly base cover define a dental utility housing utility pathway that directs dental utilities from the dental utility platform to the dental delivery assembly main arm. Also included are a dental utility platform, and a dental utility platform extendable mount. The dental utility platform extendable mount permits the dental utility platform to be positioned anywhere along a continuous range of positions.

### CROSS-REFERENCE TO RELATED APPLICATIONS

This application claims priority under 35 USC §119 to U.S. Provisional Patent Application No. 61/117,208 filed Nov. 23, 2008. The teachings of this application are incorporated herein in its entirety.

### FIELD OF THE INVENTIONS

This invention relates to dental utility cabinet for storing dental utilities. More particularly this invention relates to dental utility cabinet with an extendable drawer on which utility infrastructure can be mounted.

### BACKGROUND

Conventional dental cabinets used in dental operatories can be required to serve a dual role. The cabinets serve as an area in which dental equipment can be stored. Included in this equipment are dental tools, some of which require utilities, including but not limited to electrical power, compressed air, vacuum, pressure, water, computer and video network cabling, and/or nitrous oxide. The cabinets may then also serve as an area in which the utility connections to the tools are made. These connections can include couplers, valves, pressure regulating devices, metering devices, electric power supply or electronic control equipment etc, which must be mounted somewhere. Often times, the connections are made and the mounting is done inside the dental utility cabinet, thus giving the dental cabinet the second role as a utility area.

As the complexity of dental operatories increases with advances in technology, more utilities are required, and thus the utility portion of the dental cabinet increases in size and complexity. However, the inventors have realized that the dental cabinets are not experiencing a corresponding increase in interior volume to accommodate the increased utilities. The inventors further realized that the area within the dental cabinet devoted to utilities is becoming more crowded. As this area becomes more crowded, it is becoming increasingly difficult to design dental cabinets to accommodate these utilities and associated equipment. In addition, once the cabinets are built, it can be very difficult to actually install these components within the space allotted. The problem associated with these crowded utility installations becomes greatly pronounced once the dental cabinet has been installed in a dental operatory, and maintenance of a utility is required. With utilities installed in such confined spaces, maintenance can require at least awkward access by maintenance personnel, and in extreme cases, may require extensive disassembly of the surrounding cabinetry solely to permit access to the utility. As a result, maintenance costs, down time losses, and customer dissatisfaction may increase.

### BRIEF DESCRIPTION OF THE INVENTIONS

Connections between the dental utility service supply lines and the dental utility lines leading to the dental tools, which often include valves, gauges, regulating devices, and associated electric and electronic equipment etc are usually made within the cabinet or similar structure, which are often difficult to reach. This results in more time spent installing and maintaining the connections, valves, gauges, regulating devices, and associated electric and electronic equipment etc. Consequently, assembly and maintenance costs can be high. Still further, difficulty in maintaining the components may result in downtime, which may be a source of inconvenience for the dental personnel, and dental patients. The present inventors have recognized this, and as a result, the inventors of the present invention have designed a dental utilities cabinet with a readily accessible dental utilities assembly platform, such that these utilities, utility connection hardware, valves, gauges, electric and electronic equipment etc can be readily accessed. This dental utility cabinet may further include a pathway that leads dental utilities to an attached dental utility main arm, through which the utilities may be routed. A dental workstation could be attached to the dental utility main arm, thus completing a dental delivery system.

In an embodiment, the inventions pertain to a dental rear delivery unit for enabling a doctor and dental assistant to treat a patient using dental handpieces and instruments from the head end of a dental chair. The delivery unit includes a doctor handpiece delivery head for supporting doctor handpieces and operator interfaces for controlling the operation of the handpieces. The doctor delivery head is substantially free of infrastructure supporting utilities that are provided to the handpieces, which enables the size of the doctor delivery head to be reduced and provides freedom of positioning of the doctor delivery head adjacent the patient. The delivery unit also includes a doctor flex arm carrying the doctor handpiece delivery head, together with power cable and signal cable for the delivery of utilities to the doctor handpieces. The delivery unit of this embodiment further may include an assistant instrument delivery head for supporting assistant instrument and interfaces for controlling the operation of the instruments, but being substantially free of infrastructure supporting utilities provided to the instruments for enabling the size of the assistant delivery head size to be reduced and provide freedom of positioning of the assistant delivery head adjacent the patient. An assistant flex arm carries the assistant handpieces delivery head, together with fluid conduits for the delivery of utilities to the assistant instruments.

The delivery unit also includes a cabinet generally at the head end of the dental chair that is intended to receive power and fluid from sources in the cabinet. The cabinet is in communication with the power cable, signal cable and fluid conduits for providing utilities to the doctor handpieces and assistant instruments. The cabinet also has a dental utility drawer slideably mounted therein housing infrastructure for the delivery and conditioning of the utilities to the doctor handpieces and assistant instruments and enabling inspection and servicing of the infrastructure.

The utilities provided to the delivery heads typically involve electrical power, optical power, fluid under pressure and suction for fluid removal. The doctor handpieces and assistant instrument interfaces control the delivery of power and fluid to and from the handpieces and assistant instruments.

The dental rear delivery unit may further include a flexible channel holding cable and fluid conduits extending from adjacent the infrastructure in the drawer to adjacent the cable and conduits in the flex arms for enabling the drawer to be moved between open and closed positions. In one embodiment, the flexible channel comprises a chain carrier device secured at one end thereof to the drawer and at the other end thereof to a stationary portion of the cabinet.

The dental rear delivery unit may further include a cable and conduit holder in the cabinet for holding the cable and fluid conduits in a predetermined order. In an embodiment, the holder comprises a plurality of segments flexibly secured together for movement between an unlocked position in which the cable and fluid conduits may be positioned between the segments and a locked position in which the cable and conduits are held in place in the holder. The segments may define cooperating sets of recesses for holding the cables and conduits in place in the holder when the segments are moved to the locking mode. The cooperating sets of recesses may be of various sizes to receive and hold various size cables and fluid conduits.

The utility infrastructure may include, but is not limited to, AC/DC electric adaptors, transformers, electrical switches, electronic processors, electronic controllers, optical sensors, optical sources, fluid pressure regulators, fluid filter devices and/or fluid flow control valves. The infrastructure may further comprise electrical connectors for connecting cables from the source of electrical power to the power cables for the flex arms. Further still, the infrastructure may further comprise unions for connecting fluid conduits from sources of fluid to the fluid conduits for the flex arms.

The dental utility system may include a dental utility housing for supporting components of the dental utility system, including one or more structural members that define a utility space, a front side, and a plane defined by a coronal cross section of the front side, a dental delivery assembly base fixed to the dental utility housing at the front side, a dental delivery assembly main arm pivotably connected to the dental delivery assembly base, the main arm having a proximal end and a distal end with the proximal end being the attachment location of the arm to the base. A dental delivery assembly base cover may be removably connected to the dental utility system housing. The dental delivery assembly base and dental delivery assembly base cover define a dental utility housing utility pathway that directs dental utilities from the dental utility platform to the dental delivery assembly main arm.

The dental utility system may further include infrastructure mounted in the dental utility system housing which enables the delivery and conditioning of the utilities to doctor handpieces and assistant instruments, which provides for inspection and servicing of the infrastructure. The system includes a dental utility drawer slidably mounted to the housing that supports and organizes the infrastructure. Also included is a dental utility platform extendable mount for supporting the weight of and providing a range of motion to the dental utility drawer, wherein the dental utility platform extendable mount is connected to the dental utility drawer and the dental utility housing. The dental delivery assembly base and dental delivery assembly base cover define a dental utility housing utility pathway that directs dental utilities from the housing to the dental delivery assembly main arm. The main arm may optionally include a conduit for guiding the dental utilities from the proximal end to the distal end of the main arm.

The dental utility platform extendable mount permits the dental utility platform to be positioned anywhere along a continuous range of positions, the range of positions including a fully retracted position where the dental utility platform and the dental utility platform extendable mount are substantially within the dental utility housing, and a fully extended position where the dental utility platform is substantially outside the dental utility housing, and wherein the range of motion is transverse to a plane defined by a coronal cross section of a front portion of the dental utility housing.

The dental cabinet system for containing and managing dental utilities may also include a dental utility drawer suitable to support, guide, constrain movement of, and provide maintenance access to service to utility infrastructure, and a structural framework in the cabinet that defines a dental utility housing cavity such that when the dental utility drawer is in a fully retracted position the dental utility drawer is substantially within the dental utility housing cavity. Also included is a dental delivery assembly base fixed to the front side of the dental housing cavity and a dental delivery assembly main arm having a proximal end and a distal end, wherein the dental delivery assembly main arm is pivotably connected to the dental delivery assembly base at the proximal end.

The dental delivery assembly base and dental delivery assembly base cover define a dental utility pathway that directs cables and conduits from the dental utility housing to the dental delivery assembly main arm. Further included in the dental cabinet system is a dental utility platform extendable mount connected to the dental utility drawer and the dental utility structural framework that supports the dental utility drawer as the dental utility drawer moves through a range of dental utility drawer positions, the range of dental utility drawer positions including a fully retracted position and a fully extended position. Finally, included in the dental cabinet system is a dental cabinet assembly including a dental cabinet enclosure that has front side. The dental cabinet enclosure defining a space that has an opening at the front side. Furthermore, a coronal cross section of the dental cabinet enclosure front side defines a dental cabinet enclosure front plane behind which said dental utility drawer is when in the fully retracted position.

A dental utility platform extendable mount for supporting the weight of and providing a range of motion to the dental utility drawer may also be provided, wherein the dental utility platform extendable mount is connected to the dental utility drawer. The dental utility platform extendable mount provides the dental utility drawer with a range of positions that includes a fully retracted position substantially within a dental utility housing cavity, a fully extended position substantially outside the dental utility housing cavity, and positions between the fully retracted position and the fully extended position, and wherein the dental utility platform extendable mount is also connected to the structural framework of the cabinet. The platform may further comprise service utility to dental utility connection hardware mounted to said service utility to dental utility connection hardware mount.

### BRIEF DESCRIPTION OF THE DRAWINGS

The invention is explained in the following description in view of the drawings that show:

FIG. 1 is a perspective view of a utility housing with a retractable utility platform in an extended position, including utilities on the utility platform.

FIG. 2 is a perspective view of the utility housing and extended utility platform of FIG. 1, without the utilities shown in FIG. 1, but with a front cover in an extended position, installed in a dental cabinet equipped with a portion of a hinged utility delivery system shown as an arm.

FIG. 3 is a perspective view of the utility housing, extended platform, and cabinet of FIG. 2, with the utility cover of the utility platform removed.

FIG. 4 is a perspective view of the dental cabinet, utility housing, and platform of FIG. 3, in a completely stowed condition, with a utility delivery system cover in place.

FIG. 5 shows a rear perspective view showing an embodiment comprising a flexible channel holding cable and fluid conduits extending from adjacent the infrastructure supported in a dental utility drawer.

FIG. 6 shows a perspective view of a chain carrier that may be implemented as the flexible channel revealed in FIG. 5.

FIG. 7 shows a front perspective view of a dental utility housing system that includes a cable and conduit holder.

FIG. 8 shows a perspective view of a dental utility housing with flexibly attached doctor handpiece delivery head and assistant instrument delivery head.

FIG. 9 shows a top, plan view of a typical dental operatory.

### DETAILED DESCRIPTION

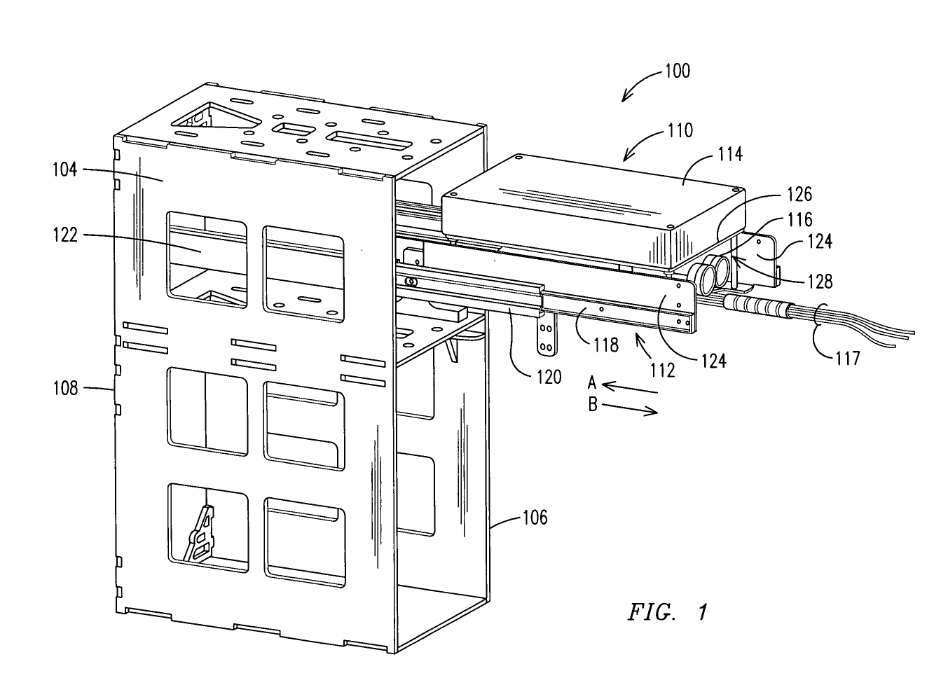

Turning to the drawings, FIG. 1 shows a perspective view of a dental utility system 100 including a dental utility system housing 104, a dental utility drawer assembly 110, a dental utility extendable platform mount 112, dental utility gauges 116 and dental utility lines 117.

The dental utility system housing 104 includes a dental utility system housing front side 106, which defines a dental utility system housing front side plane, and a dental utility system back side 108. The dental utility system housing 104 provides structural support for the dental utility extendable platform mount 112 and dental utility system platform assembly 110.

The dental utility system platform assembly 110 includes dental utility drawer assembly framework 124, dental utility drawer assembly plate 126 to which dental utilities and dental utility connection hardware may be mounted, dental utility drawer assembly spacers 128, and dental utility drawer assembly cover 114. Dental utility gauges 116 and dental utility lines 117 can be mounted to the dental utility drawer assembly framework 124, and/or to the top and/or bottom of dental utility drawer assembly plate 126. Dental utility drawer assembly cover 114 can cover the dental utility drawer assembly plate 126 as shown in the embodiment of FIG. 1, or can cover more or less of the dental utility system platform assembly 110.

The dental utility extendable platform mount 112 includes dental utility extendable platform mount small arm 118, dental utility extendable platform mount large arm 120, and dental utility extendable platform mount base 122. In the embodiment of FIG. 1, dental utility drawer extends linearly in direction A, and retracts linearly in direction B. However other extendable mounts are contemplated, which may or may not extend linearly. It can be seen from the embodiment in FIG. 1 that when in the extended position, dental utility drawer assembly 110 extends beyond dental utility system housing front side 106. Other embodiments are contemplated in which the dental utility drawer assembly 110 may extend further or only partially beyond dental utility system housing front side 106. When in the retracted position, dental utility drawer assembly 110 retracts to a position substantially inside dental utility system housing 104. It is also contemplated that dental utility drawer assembly 110 be able to retract to a position completely inside dental utility system housing 104.

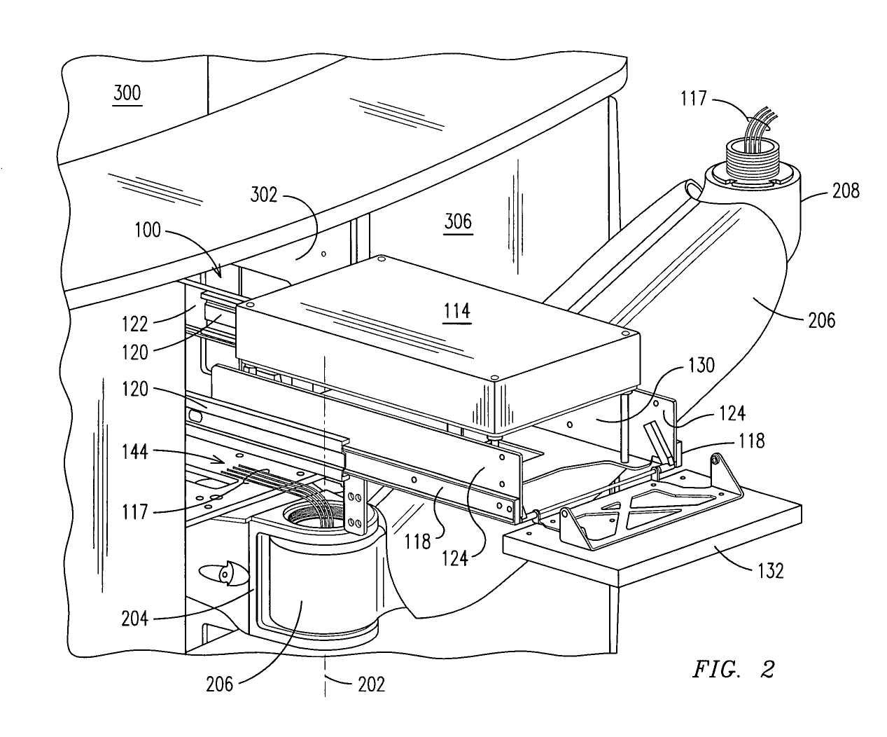

FIG. 2 shows a perspective view of the dental utility system 100 of FIG. 1 positioned within dental cabinet space 302 of dental cabinet 300. Dental cabinet 300 has a dental cabinet front 306, which defines a plane that is positioned in front of the dental utility system housing front side 106. Dental delivery assembly base 204 is also shown attached to the cabinet front side 106. Dental utility cables and conduits can be routed from the dental utility system platform assembly 110 to a dental delivery assembly base 204 via a dental utility housing utility pathway 144. Dental delivery assembly base 204 further includes dental delivery assembly base vertical axis 202. Attached to dental delivery assembly base 204 is a dental delivery assembly main arm 206, which pivots horizontally about dental delivery assembly base vertical axis 202, and which comprises a dental delivery main arm channel 146 through which utility lines 117 can be routed from the dental utility system platform assembly 110 to dental tools (not shown). Dental delivery assembly main arm 206 permits dental delivery assembly main arm distal end 208 the freedom to move up and down while dental delivery assembly base 204 pivots about dental delivery assembly base vertical axis 202. The various mechanisms that can be used for this are known to those of ordinary skill in the art. FIG. 2 also shows dental utility system platform assembly front cover 132 in an extended position, which is hinged to provide a decorative cover as well as visual and manual access to the dental utility system platform assembly 110 and infrastructure. Dental utility system platform cubby 130 provides room for infrastructure, such as but not limited to, gauges 116 and dental utility lines 117 etc. Also visible are dental utility extendable platform mount small arm 118, dental utility extendable platform mount large arm 120, dental utility extendable platform mount base 122, and dental utility drawer assembly framework 124.

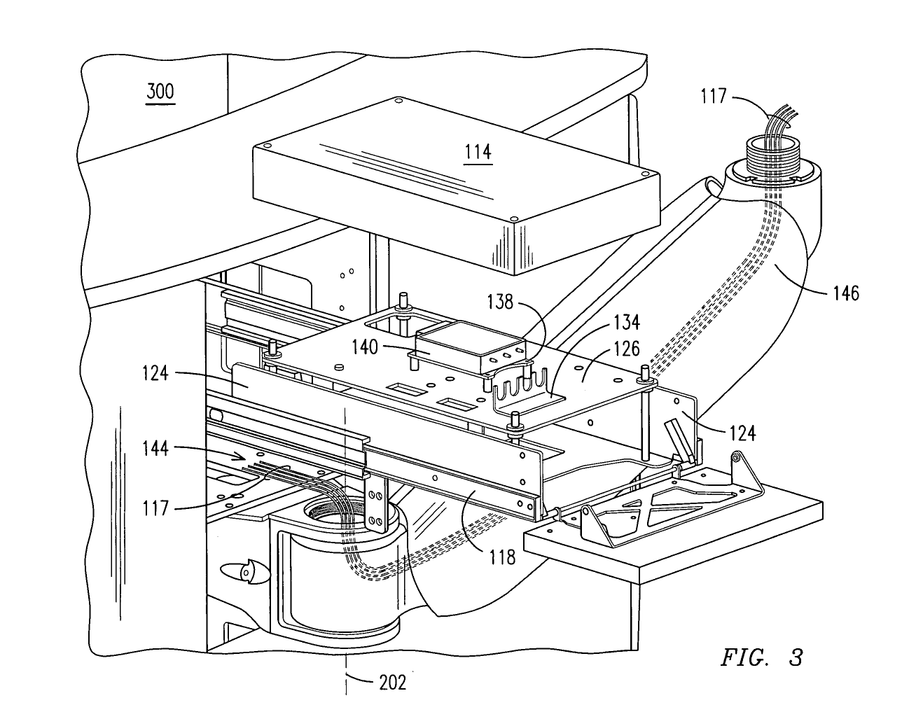

FIG. 3 shows a perspective view of the dental utility system 100 and dental cabinet 300 of FIG. 2, with the dental utility drawer assembly cover 114 removed, exposing dental utility drawer assembly plate 126. An exemplary utility connection hardware mount 134 is attached to dental utility drawer assembly plate 126, and may hold hardware for making connections between dental utility service lines and dental utility lines that lead to dental handpieces. An exemplary second utility connection hardware mount 138 can be seen in this embodiment. The exemplary second utility connection hardware mount 138 of this embodiment mounts dental equipment 140 associated with dental utilities and utility connections to dental utility drawer assembly plate 126. The hardware mounts contemplated include any configuration that assists in the connection of dental utility service supply lines with dental utility lines leading to dental handpieces. Also considered are hardware mounts that mount any other infrastructure components discussed herein, including but not limited to shut off valves, pressure regulators, pressure gauges, flow meters, electrical equipment, electronic equipment, imaging or computer equipment etc. Hardware mounts that mount dental utility lines themselves are also contemplated. Dental utility drawer assembly plate 126 serves as a rigid structure to which utilities, utility connection hardware, utility connection hardware mounts, and utility monitoring and other dental equipment can be attached. In this embodiment dental utility drawer assembly plate 126 is a plate, but any configuration that serves this function will be adequate. Also visible are dental utility extendable platform mount small arm 118, dental utility extendable platform mount large arm 120, dental utility extendable platform mount base 122, and dental utility drawer assembly framework 124.

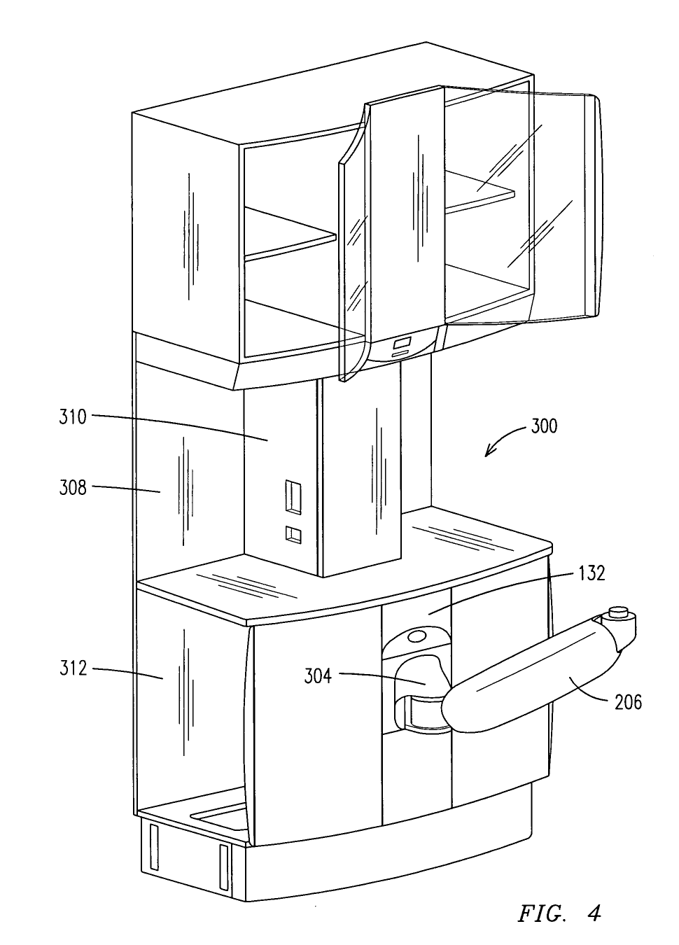

FIG. 4 shows a perspective view of the dental utility system 100 and dental cabinet 300, with a dental delivery assembly base cover 304 installed to provide a decorative cover for the dental delivery assembly base 204, and dental utility system platform assembly front cover 132 in a retracted position. Dental cabinet 300 further comprises a structural back member 308, a central structural member 310, and a dental item storage area 312.

Thus, when looking at the dental utility drawer assembly 110 as seen in the extended position, where dental utility drawer assembly cover 114 is removed, as in FIG. 3, it can be seen that the infrastructure is readily accessible for inspection and maintenance purposes. Yet, as seen in FIG. 4, it can also be seen that when in the retracted position, infrastructure is neatly and efficiently stored entirely within dental cabinet 300, completely out of sight and out of the way of those using dental handpieces, including the dentist, dental assistant, and patient. Also seen is that the dental utility drawer assembly 110 travels in a linear path in a vector transverse to the front of the dental cabinet. In an embodiment dental utility drawer assembly 110 travels at 90 degrees to the front of the dental cabinet, but other angles are contemplated. When the dental utility drawer assembly 110 is in the fully extended position it is substantially on the other side of dental cabinet front 306, and the plane defined by dental cabinet front 306, than when dental utility drawer assembly 110 is in the fully retracted position. Embodiments are contemplated in which dental utility drawer assembly 110 is entirely on the opposite side of dental cabinet front 306.

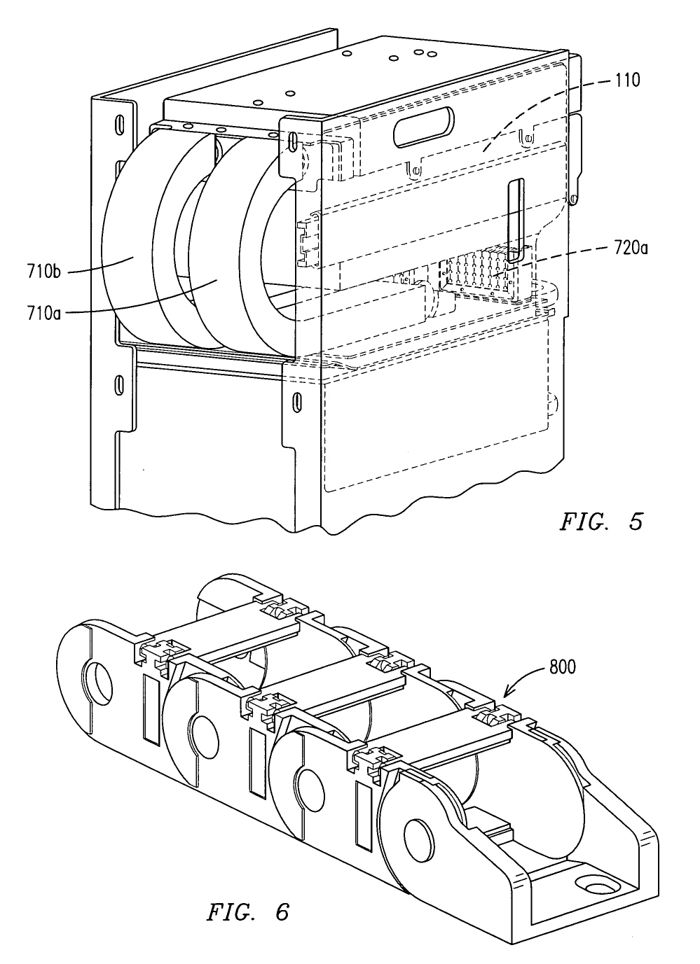

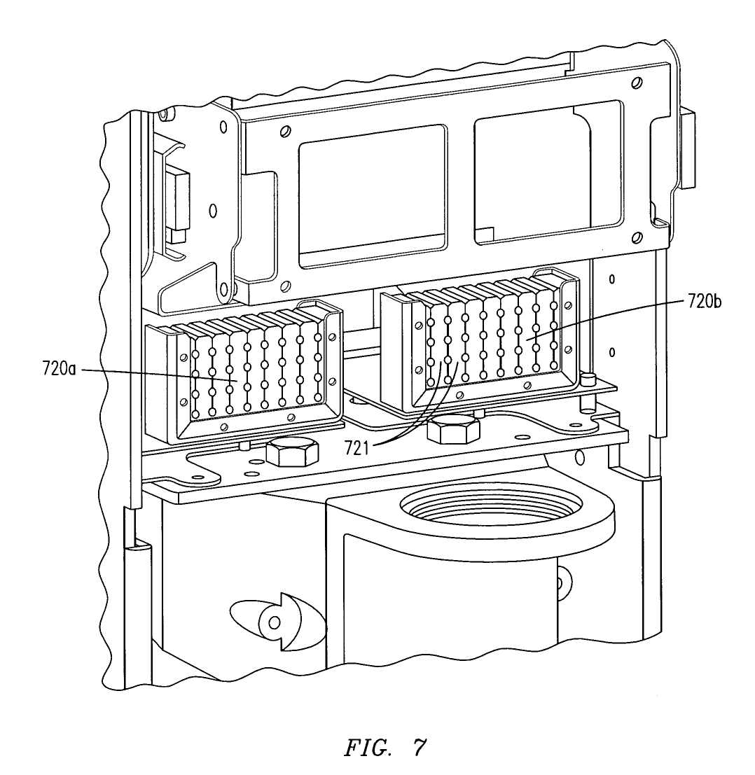

FIG. 5 shows a rear perspective view of dental utility housing system that includes a dental utility drawer assembly 110 supporting dental utility infrastructure (not shown) similar to that as described above and a first and second flexible channels 710a and 710b for holding cable and fluid conduits extending from adjacent the infrastructure supported in a dental utility drawer. The flexible channels 710a,b curve around to guide cable and fluid conduits toward a cable and conduit holder 720a that is subjacent to the dental utility drawer assembly 110. FIG. 6 shows a nonlimiting example of a chain carrier 800 which is just one type of flexible channel that may be implemented. FIG. 7 shows a front perspective view of the dental utility housing system shown in FIG. 5 that provides a view of cable and conduit holder 720a and a second cable and conduit holder 720b. Cables and conduits are directed from flexible channels 710a and 710b to cable and conduit holders 720a and 720b, respectively. The holders 720a,b comprise a plurality of segments 721 flexibly secured together for movement between and unlocked position in which the cable and fluid conduits may be positioned between the segments and a locked position in which the cable and conduits are held in place in the holders 720a,b.

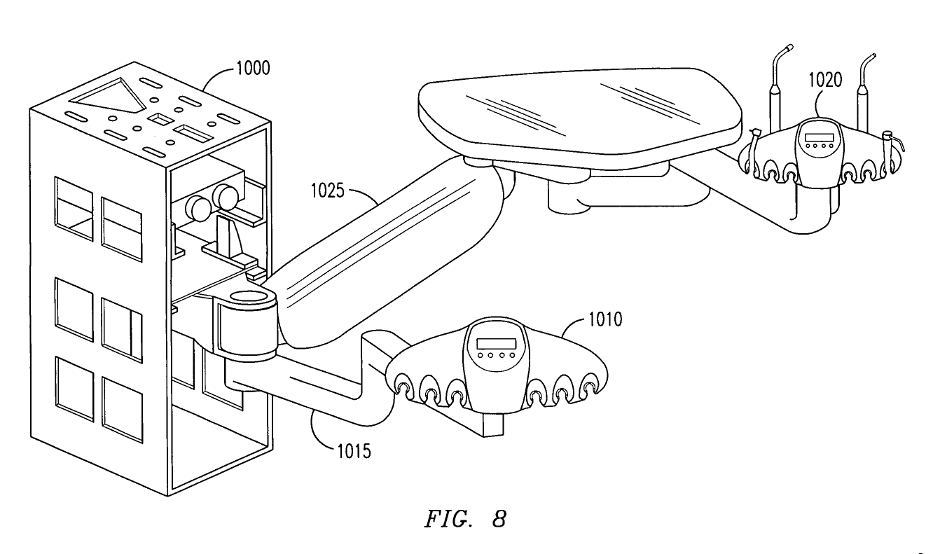

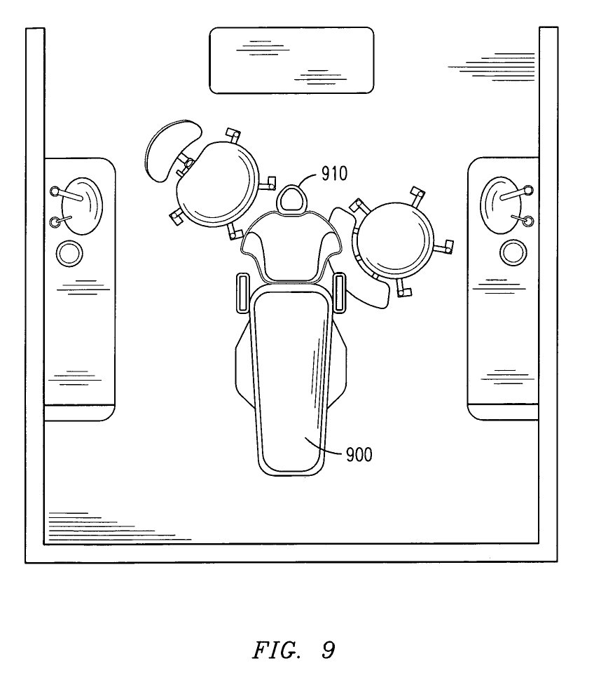

FIG. 8 shows a perspective view of a dental utility housing 1000 with flexibly attached doctor handpiece delivery head 1010 and assistant instrument delivery head 1020. The doctor handpiece delivery head 1010 is connected to the housing via a doctor flex arm 1015 carrying the doctor handpiece delivery head, together with power cable and signal cable for the delivery of utilities to doctor handpieces (not shown) held by the doctor handpiece delivery head 1010. The assistant instrument delivery head 1020 is connected to the housing via an assistant flex arm 1025 carrying the assistant handpieces delivery head, together with fluid conduits for the delivery of utilities to the assistant instruments (not shown) held by the assistant handpieces delivery head. These components provide a dental rear delivery unit for enabling a doctor and dental assistant to treat a patient using dental handpieces and instruments from the head end of a dental chair.

Reference is made herein to a head end of a dental chair. FIG. 9 shows a top plan view of a typical dental operatory. FIG. 9 includes an example of a dental chair 900 having a head end 910.

While it is known to have utility lines to the dental tools themselves extend past dental cabinets, through these inventions the inventors have innovatively also enabled simple access to the valves and connections used to connect the utility lines from the dental tools to the utility service sources, access to the metering devices that regulate the flow within the dental utility lines to the dental tools, and access to the gauges that monitor the dental utilities. Consequently, installation and maintenance operations are made easier, which results in reduced manufacturing costs, reduced maintenance costs, and reduced inconvenience to dental personnel and customers resulting from maintenance downtime.

While various embodiments of the present inventions have been shown and described herein, it will be obvious that such embodiments are provided by way of example only. Numerous variations, changes and substitutions may be made without departing from the inventions herein. Accordingly, it is intended that the inventions be limited only by the spirit and scope of the appended claims.

The invention claimed is:

1. A dental rear delivery unit for enabling a doctor and dental assistant to treat a patient using dental handpieces and instruments from the head end of a dental chair, the delivery unit comprising:
a doctor handpiece delivery head for supporting doctor handpieces and operator interfaces for controlling the operation of the handpieces, but being substantially free of infrastructure supporting utilities provided to the handpieces for enabling the size of the doctor delivery head size to be reduced and provide freedom of positioning of the doctor delivery head adjacent the patient;
a doctor flex arm carrying the doctor handpiece delivery head, together with power cable and signal cable for the delivery of utilities to the doctor handpieces;
an assistant instrument delivery head for supporting assistant instrument and interfaces for controlling the operation of the instruments, but being substantially free of infrastructure supporting utilities provided to the instruments for enabling the size of the assistant delivery head size to be reduced and provide freedom of positioning of the assistant delivery head adjacent the patient;
an assistant flex arm carrying the assistant handpieces delivery head, together with fluid conduits for the delivery of utilities to the assistant instruments; and
a cabinet generally at the head end of the dental chair receiving power and fluid from sources thereof and being in communication with the power cable, signal cable and fluid conduits for providing utilities to the doctor handpieces and assistant instruments, with the cabinet having a drawer slideably mounted therein housing infrastructure for the delivery and conditioning of the utilities to the doctor handpieces and assistant instruments and enabling inspection and servicing of the infrastructure.

2. The dental rear delivery unit of claim 1 wherein the utilities comprise electrical power and optical power.

3. The dental rear delivery unit of claim 1 wherein the utilities comprise fluid under pressure and suction for fluid removal.

4. The dental rear delivery unit of claim 1 wherein the doctor handpieces and assistant instrument interfaces control the delivery of power and fluid to and from the handpieces and assistant instruments.

5. The dental rear delivery unit of claim 1 further comprising a flexible channel holding cable and fluid conduits extending from adjacent the infrastructure in the drawer to adjacent the cable and conduits in the flex arms for enabling the drawer to be moved between open and closed positions.

6. The dental rear delivery unit of claim 5 wherein the flexible channel comprises a chain carrier device secured at one end thereof to the drawer and at the other end thereof to a stationary portion of the cabinet.

7. The dental rear delivery unit of claim 1 further comprising a cable and conduit holder in the cabinet for holding the cable and fluid conduits in a predetermined order.

8. The dental rear delivery unit of claim 1 wherein the holder comprises a plurality of segments flexibly secured together for movement between an unlocked position in which the cable and fluid conduits may be positioned between the segments and a locked position in which the cable and conduits are held in place in the holder.

9. The dental rear delivery unit of claim 8 wherein the segments define cooperating sets of recesses for holding the cables and conduits in place in the holder when the segments are moved to the locking mode.

10. The dental rear delivery unit of claim 9 wherein the cooperating sets of recesses are of various sizes to receive and hold various size cables and fluid conduits.

11. The dental rear delivery unit of claim 1 wherein the infrastructure is selected from the group comprising AC/DC electric adaptors, transformers, electrical switches, electronic processors, electronic controllers, optical sensors, optical sources, fluid pressure regulators, fluid filter devices and fluid flow control valves.

12. The dental rear delivery unit of claim 11 wherein the infrastructure further comprises electrical connectors for connecting cables from the source of electrical power to the power cables for the flex arms.

13. The dental rear delivery unit of claim 11 wherein the infrastructure further comprises unions for connecting fluid conduits from sources of fluid to the fluid conduits for the flex arms.

14. A dental utility system for managing dental utilities, comprising:
a dental utility housing for supporting components of the dental utility system, the housing comprising a front side and a back side and one or more structural members that define a utility space,
a dental delivery assembly base associated with the dental utility housing and positioned at said front side,
a dental delivery assembly main arm comprising a proximal end and a distal end, the proximal end being pivotably connected to the dental delivery assembly base,
a dental delivery assembly base cover removably connected to the dental utility system housing, wherein the dental delivery assembly base and dental delivery assembly base cover define a dental utility housing utility pathway that directs dental utilities from the housing to the dental delivery assembly main arm;
a dental utility drawer for supporting dental utility infrastructure; and
a dental utility platform extendable mount for supporting the weight of and providing a range of motion to the dental utility drawer, wherein the dental utility platform extendable mount is connected to the dental utility drawer and the dental utility so as to permit the dental utility drawer to be positioned anywhere along a continuous range of positions, the range of positions comprising a fully retracted position where the dental utility drawer and the dental utility platform extendable mount are substantially within the dental utility housing, and a fully extended position where the dental utility drawer is substantially outside the dental utility housing.

15. The dental utility system of claim 14, wherein the dental utility drawer further comprises a service utility to dental utility connection hardware mount.

16. The dental utility system of claim 14, wherein the dental utility platform extendable mount is linearly extendable transverse to a plane defined by a coronal cross section of a front portion of the dental housing.

17. The dental utility system of claim 14, wherein the dental delivery assembly main arm further comprises a dental delivery assembly main arm utility channel that directs dental utilities from the proximal end to the distal end of the dental delivery assembly main arm.
